(19) United States
(12) Patent Application Publication
(10) Pub. No.: US 2005/0061803 A1
(43) Pub. Date: Mar. 24, 2005

(54) Apparatus for induction heating and method of making

(75) Inventors: Kiruba Sivasubramaniam, Troy, NY (US); Mehmet Arik, Niskayuna, NY (US); John Stanley Glaser, Niskayuna, NY (US)

Correspondence Address: General Electric Company;GRC Patent Docket Rm 4A59, Bldg. K-1, P.O. Box 8, Schenectady, NY, 12301, US

(73) Assignee: General Electric Company

(21) Appl. No.: 10/666,348

(22) Filed: Sep. 18, 2003

(51) Int. Cl. H05B 6/00

(52) U.S. Cl. 219/618

(57) ABSTRACT

An apparatus for induction heating, the apparatus comprising: a plurality of heat transfer plates, each of the heat transfer plates being disposed radially with respect to a core axis; and a plurality of core sections disposed between respective pairs of the heat transfer plates and shaped to form a cylindrical core assembly.

### BACKGROUND

The present invention relates generally to the field of induction heating and more specifically to the field of magnetic core assemblies for induction heating.

In a wide variety of applications, an induction heating coil is used in conjunction with a magnetic core to produce a desired amount of power in a thermal load. The induction heating coil together with the magnetic core constitute an induction heating system. The magnetic core advances at least two performance objectives. First, the core increases the system's magnetizing reactance and thereby reduces the ampere-turns required to produce the desired power. Second, the core confines the coil's magnetic flux and thereby shields any electronic or metallic parts nearby. In conventional magnetic core designs, both of these performance objectives are addressed by selecting a ferromagnetic core material.

It is often desirable, however, that the magnetic core design additionally satisfy two operating constraints: first, that the power loss due to core eddy currents be less than a prescribed power loss limit; and second, that the core temperature be less than a prescribed operating temperature limit. Conventional magnetic core designs would be well served in satisfying these constraints by a core material that was simultaneously a good thermal conductor and a poor electrical conductor. Unfortunately, since most good thermal conductors are also good electrical conductors, it is difficult to satisfy both operating constraints by material selection alone.

Conventional magnetic core designs typically compromise, then, by using a ferromagnetic and relatively poorly electrically conductive core material to satisfy the performance objectives and eddy current power loss constraint and by using external cooling means to satisfy the operating temperature constraint. In some instances, such external cooling means represent a significant cost to the overall induction heating system. Opportunities exist, therefore, to reduce induction heating system cost by finding a novel magnetic core geometry that permits the introduction of higher electrical conductivity materials without producing excessive eddy current losses.

### SUMMARY

The opportunities described above are addressed, in one embodiment of the present invention, by an apparatus for induction heating, the apparatus comprising: a plurality of heat transfer plates, each of the heat transfer plates being disposed radially with respect to a core axis; and a plurality of core sections disposed between respective pairs of the heat transfer plates and shaped to form a cylindrical core assembly.

The present invention is also embodied as a method of making an apparatus for induction heating, the method comprising: disposing a plurality of heat transfer plates radially with respect to a core axis; and disposing a plurality of core sections between respective pairs of the heat transfer plates, the core sections being shaped to form a cylindrical core assembly.

### DRAWINGS

These and other features, aspects, and advantages of the present invention will become better understood when the following detailed description is read with reference to the accompanying drawings in which like characters represent like parts throughout the drawings, wherein:

FIG. 1 illustrates an isometric drawing in accordance with one embodiment of the present invention.

FIG. 2 illustrates an isometric drawing in accordance with another embodiment of the present invention.

FIG. 3 illustrates an orthographic drawing in accordance with still another embodiment of the present invention.

### DETAILED DESCRIPTION

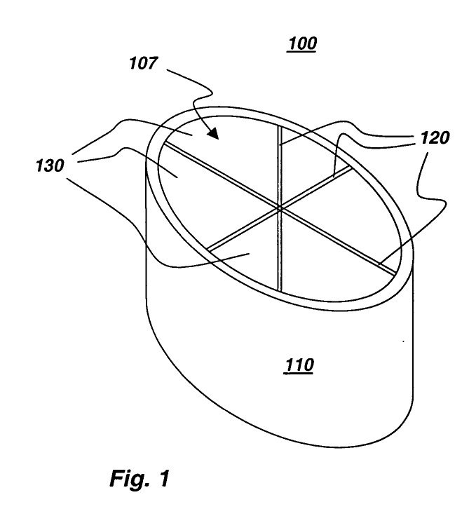

In accordance with one embodiment of the present invention, FIG. 1 illustrates an isometric drawing of an apparatus 100 for induction heating. Apparatus 100 comprises a plurality of heat transfer plates 120 and a plurality of core sections 130. Each one of heat transfer plates 120 is disposed radially with respect to a core axis and provides a heat conduction path. Core sections 130 are disposed between respective pairs of heat transfer plates 120 and shaped to form a cylindrical core assembly 107. Core sections 130 provide a magnetic flux path. As used herein, “cylinder” and “cylindrical” refer to a surface swept by a straight line moving parallel to a given straight line and intersecting a given planar closed curve.

In a more specific embodiment in accordance with the embodiment of FIG. 1, cylindrical core assembly 107 has the shape of a circular cylinder. As used herein, a “circular cylinder” is a cylinder wherein the given planar closed curve is a circle.

In another embodiment in accordance with the embodiment of FIG. 1, apparatus 100 further comprises a cylindrical outer shell 110 disposed to surround cylindrical core assembly 107.

In another more specific embodiment in accordance with the embodiment of FIG. 1, cylindrical outer shell 110 comprises a metal or combination of metals. In this embodiment, cylindrical outer shell 110 serves as a heat transfer surface. Compared to most materials, metals are relatively good thermal and electrical conductors. However, as magnetic flux lines are generally parallel to the axis of cylindrical outer shell 110, excessive eddy current losses can be avoided by making cylindrical outer shell 110 sufficiently thin.

In another more specific embodiment in accordance with the embodiment of FIG. 1, cylindrical outer shell 110 comprises a material or combination of materials selected from the group consisting of aluminum nitride and boron nitride. In comparison to most materials, the materials in this group are relatively good thermal conductors and relatively poor electrical conductors. In another more specific embodiment in accordance with the embodiment of FIG. 1, heat transfer plates 120 comprise a material or combination of materials selected from this group.

In another more specific embodiment in accordance with the embodiment of FIG. 1, heat transfer plates 120 comprise a metal or combination of metals. As magnetic flux lines are generally parallel to the larger surfaces of heat transfer plates 120, excessive eddy current losses can be avoided by making heat transfer plates 120 sufficiently thin.

In another more specific embodiment in accordance with the embodiment of FIG. 1, core sections 130 comprise a ferromagnetic material.

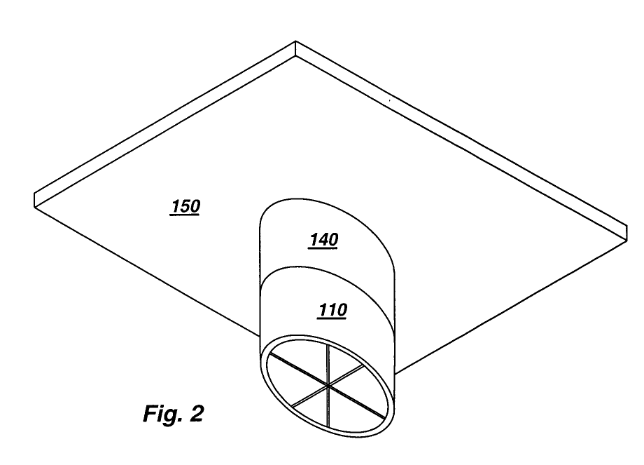

In accordance with another embodiment of the present invention, FIG. 2 illustrates an isometric drawing of apparatus 100 further comprising a coil winding 140 disposed above cylindrical core assembly 107. In operation, coil winding 140 functions as an induction heating coil.

In a more specific embodiment in accordance with the embodiment of FIG. 2, apparatus 100 further comprises a support platform 150 disposed above cylindrical core assembly 107. In operation, support platform 150 supports a thermal load (not shown). By way of example, but not limitation, a typical application for apparatus 100 is as part of a cooking appliance. In such an application, the thermal load is typically a cooking vessel such as, for example, without limitation, a pot or a pan. In some embodiments, a heat shielding material is inserted between support platform 150 and cylindrical core assembly 107 to prevent excessive heating of support platform 150.

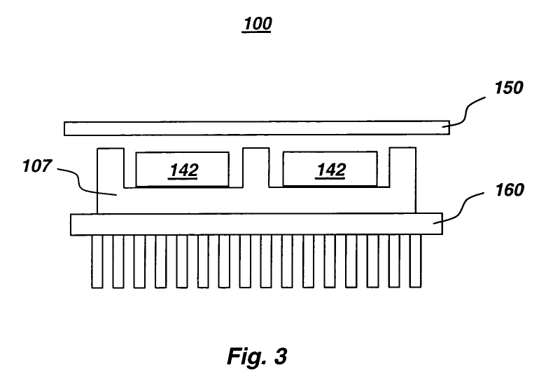

In accordance with still another embodiment of the present invention, FIG. 3 illustrates an orthographic drawing wherein apparatus 100 further comprises an annular coil winding 142 disposed at least partially inside an annular recess in cylindrical core assembly 107.

In another embodiment in accordance with the embodiment of FIG. 3, apparatus 100 of further comprises a heat sink 160 disposed below and thermally coupled to cylindrical core assembly 107. In some embodiments, the thermal coupling of heat sink 160 to cylindrical core assembly 107 is facilitated by the use of a thermally conductive paste or solder.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An apparatus for induction heating, said apparatus comprising
a plurality of heat transfer plates, each of said heat transfer plates being disposed radially with respect to a core axis; and
a plurality of core sections disposed between respective pairs of said heat transfer plates and shaped to form a cylindrical core assembly.

2. The apparatus of claim 1 wherein said cylindrical core assembly has the shape of a circular cylinder.

3. The apparatus of claim 1 further comprising a cylindrical outer shell disposed to surround said cylindrical core assembly.

4. The apparatus of claim 3 wherein said cylindrical outer shell comprises a metal or combination of metals.

5. The apparatus of claim 3 wherein said cylindrical outer shell comprises a material or combination of materials selected from the group consisting of aluminum nitride and boron nitride.

6. The apparatus of claim 1 wherein said heat transfer plates comprise a metal or combination of metals.

7. The apparatus of claim 1 wherein said heat transfer plates comprise a material or combination of materials selected from the group consisting of aluminum nitride and boron nitride.

8. The apparatus of claim 1 wherein said core sections comprise a ferromagnetic material.

9. The apparatus of claim 1 further comprising a coil winding disposed above said cylindrical core assembly.

10. The apparatus of claim 1 further comprising an annular coil winding disposed at least partially inside an annular recess in said cylindrical core assembly.

11. The apparatus of claim 1 further comprising a support platform disposed above said cylindrical core assembly.

12. The apparatus of claim 1 further comprising a heat sink disposed below and thermally coupled to said cylindrical core assembly.

13. An apparatus for induction heating, said apparatus comprising:
a plurality of heat transfer plates, each of said heat transfer plates being disposed radially with respect to a core axis;
a plurality of core sections disposed between respective pairs of said heat transfer plates and shaped to form a cylindrical core assembly;
a support platform disposed above said cylindrical core assembly; and
a heat sink disposed below and thermally coupled to said cylindrical core assembly.

14. The apparatus of claim 13 wherein said cylindrical core assembly has the shape of a circular cylinder.

15. The apparatus of claim 13 further comprising a cylindrical outer shell disposed to surround said cylindrical core assembly.

16. The apparatus of claim 13 wherein said heat transfer plates comprise a metal or combination of metals.

17. The apparatus of claim 13 wherein said core sections comprise a ferromagnetic material.

18. The apparatus of claim 13 further comprising a coil winding disposed above said cylindrical core assembly.

19. The apparatus of claim 13 further comprising an annular coil winding disposed at least partially inside an annular recess in said cylindrical core assembly.

20. A method of making an apparatus for induction heating, said method comprising:
disposing a plurality of heat transfer plates radially with respect to a core axis; and
disposing a plurality of core sections between respective pairs of said heat transfer plates, said core sections being shaped to form a cylindrical core assembly.

21. The method of claim 20 wherein said cylindrical core assembly has the shape of a circular cylinder.

22. The method of claim 20 further comprising disposing a cylindrical outer shell to surround said cylindrical core assembly.

23. The method of claim 20 wherein said heat transfer plates comprise a metal or combination of metals.

24. The method of claim 20 wherein said heat transfer plates comprise a material or combination of materials selected from the group consisting of aluminum nitride and boron nitride.

25. The method of claim 20 wherein said core sections comprise a ferromagnetic material.

26. The method of claim 20 further comprising disposing a coil winding above said cylindrical core assembly.

27. The method of claim 20 further comprising disposing an annular coil winding at least partially inside an annular recess in said cylindrical core assembly.

28. The method of claim 20 further comprising disposing a support platform above said cylindrical core assembly.

29. The method of claim 20 further comprising thermally coupling a heat sink below said cylindrical core assembly.

30. A method of making an apparatus for induction heating, said method comprising:
disposing a plurality of heat transfer plates radially with respect to a core axis;
disposing a plurality of core sections between respective pairs of said heat transfer plates, said core sections being shaped to form a cylindrical core assembly;
disposing a support platform above said cylindrical core assembly; and
thermally coupling a heat sink below said cylindrical core assembly.

31. The method of claim 30 wherein said cylindrical core assembly has the shape of a circular cylinder.

32. The method of claim 30 further comprising disposing a cylindrical outer shell to surround said cylindrical core assembly.

33. The method of claim 30 wherein said heat transfer plates comprise a metal or combination of metals.

34. The method of claim 30 wherein said heat transfer plates comprise a material or combination of materials selected from the group consisting of aluminum nitride and boron nitride.

35. The method of claim 30 wherein said core sections comprise a ferromagnetic material.

36. The method of claim 30 further comprising disposing a coil winding above said cylindrical core assembly.

37. The method of claim 30 further comprising disposing an annular coil winding at least partially inside an annular recess in said cylindrical core assembly.
